(19) United States
(12) Patent Application Publication
(10) Pub. No.: US 2024/0244388 A1
(43) Pub. Date: Jul. 18, 2024

(54) SYSTEM AND METHOD FOR SPATIAL AUDIO RENDERING, AND ELECTRONIC DEVICE

(71) Applicant: BEIJING ZITIAO NETWORK TECHNOLOGY CO., LTD., Beijing (CN)

(72) Inventors: Xuzhou YE, Beijing (CN); Chuanzeng HUANG, Beijing (CN); Junjie SHI, Beijing (CN); Zhengpu ZHANG, Beijing (CN); Derong LIU, Beijing (CN)

(21) Appl. No.: 18/620,361

(22) Filed: Mar. 28, 2024

Related U.S. Application Data
(63) Continuation of application No. PCT/CN2022/122657, filed on Sep. 29, 2022.

(30) Foreign Application Priority Data
Sep. 29, 2021 (WO) PCT/CN2021/121729

(51) Int. Cl. H04S 7/00; G10L 19/008

(52) U.S. Cl. CPC H04S 7/303; G10L 19/008; H04S 7/305; H04S 2400/11

(57) ABSTRACT

The present disclosure relates to a method for spatial audio rendering. The method comprises: on the basis of metadata, determining a parameter for spatial audio rendering, wherein the metadata comprises at least some information among acoustic environment information, listener spatial information and sound source spatial information, and the parameter for spatial audio rendering indicates a characteristic of sound propagation in a scene in which a listener is located; on the basis of the parameter for spatial audio rendering, processing an audio signal of a sound source, so as to obtain an encoded audio signal; and performing spatial decoding on the encoded audio signal, so as to obtain a decoded audio signal.

### CROSS-REFERENCE TO RELATED APPLICATIONS

The present application is a continuation of International Application No. PCT/CN2022/122657, as filed on Sep. 29, 2022, which is based on and claims the priority to the international patent application PCT/CN2021/121729 filed on Sep. 29, 2021, the disclosure of which is incorporated by reference herein in its entirety.

### TECHNICAL FIELD

The present disclosure relates to the technical field of audio signal processing, and in particular, to a system and method for spatial audio rendering, a chip, an electronic device, a computer program, a computer-readable storage medium, and a computer product.

### BACKGROUND

All sounds in a real world exist in a form of spatial audio, forming a spatial audio phenomenon in the real world.

sound originates from vibrations of an object and propagates through a medium to reach auditory organs such as human ears, thereby being heard. In the real world, vibrating objects can appear anywhere, forming a three-dimensional direction vector with a human head. A horizontal angle of the direction vector will affect a loudness difference, time difference, and phase difference of the sound reaching two ears, and a vertical angle of the direction vector will affect a frequency response of the sound reaching the two ears. It is by using this physical information that humans have gained an ability to determine a position where a sound source is located according to sound signals in the two ears, through a large amount of unconscious acquired training.

In the real world, for humans and other animals, a perceived sound has not only a direct sound directly reaching the ears from the sound source, but also sounds generated by environment reflection, scattering, and diffraction on vibration waves of the sound source, thereby generating an environment acoustic phenomenon. Environment reflection and scattering sounds will directly affect listener's aural perception of the sound source and an environment where he is located. This perceptual ability is a rationale behind an ability of a nocturnal animal such as a bat to locate itself in the dark and understand an environment where it is located.

Humans might not have sharp hearing as bats, but can also obtain a great deal of information by sensing an influence of the environment on the sound source. For example, when listening to singing of a singer, a listener can clearly distinguish whether he is listening in a large church or in a parking lot, due to different reverb durations. For another example, when listening to a song in a church, a listener can clearly distinguish whether he is listening 1 meter right ahead of a singer or 20 meters right ahead of the singer, due to different ratios of reverb to direct sound; he can also clearly distinguish whether he is listening in a center of the church or at a place where one ear is only 10 centimeters away from a wall, due to different loudness of early reflection sounds.

### SUMMARY

According to some embodiments of the present disclosure, there is provided a method for spatial audio rendering, comprising: determining, based on metadata, a parameter for spatial audio rendering, wherein the metadata comprises at least a part of acoustic environment information, listener spatial information, and sound source spatial information, and the parameter for spatial audio rendering indicates a characteristic of sound propagation in a scene in which a listener is located; processing, based on the parameter for spatial audio rendering, an audio signal of a sound source, so as to obtain an encoded audio signal; and performing spatial decoding on the encoded audio signal, so as to obtain a decoded audio signal.

According to some embodiments of the present disclosure, there is provided a system for spatial audio rendering, comprising: a scene information processor configured to determine, based on metadata, a parameter for spatial audio rendering, wherein the metadata comprises at least a part of acoustic environment information, listener spatial information, and sound source spatial information, and the parameter for spatial audio rendering indicates a characteristic of sound propagation in a scene in which a listener is located; a spatial audio encoder configured to process, based on the parameter for spatial audio rendering, an audio signal of a sound source, so as to obtain an encoded audio signal; and a spatial audio decoder configured to perform spatial decoding on the encoded audio signal, so as to obtain a decoded audio signal.

According to further embodiments of the present disclosure, there is provided a chip, comprising: at least one processor and an interface, the interface being configured to provide computer-executable instructions to the at least one processor, and the at least one processor being configured to execute the computer-executable instructions to implement the method for spatial audio rendering according to any of the embodiments in the present disclosure.

According to further embodiments of the present disclosure, there is provided a computer program, comprising: instructions which, when executed by a processor, cause the processor to perform the method for spatial audio rendering according to any of the embodiments in the present disclosure.

According to further embodiments of the present disclosure, there is provided an electronic device, comprising: a memory; and a processor coupled to the memory, the processor being configured to perform, based on instructions stored in the memory device, the method for spatial audio rendering according to any of the embodiments in the present disclosure.

According to further embodiments of the present disclosure, there is provided a computer-readable storage medium having thereon stored a computer program which, when executed by a processor, implements the method for spatial audio rendering according to any of the embodiments in the present disclosure.

According to further embodiments of the present disclosure, there is provided a computer program product, comprising instructions which, when executed by a processor, implement the method for spatial audio rendering according to any of the embodiments in the present disclosure.

Other features of the present disclosure and advantages thereof will become apparent from the following detailed description of exemplary embodiments thereof with reference to the accompanying drawings.

### BRIEF DESCRIPTION OF THE DRAWINGS

The accompanying drawings described here are intended to provide a further understanding of the present disclosure, and constitute a part of the present application, and illustrative embodiments of the present disclosure and their descriptions serve to explain the present disclosure and do not constitute an improper limitation on the present disclosure. In the drawings:

FIG. 1A is a conceptual schematic diagram illustrating configuration of a system for spatial audio rendering according to an embodiment of the present disclosure;

FIG. 1B is a schematic diagram illustrating an example of an implementation of a system for spatial audio rendering according to an embodiment of the present disclosure;

FIG. 1C is a simplified schematic diagram illustrating an application example of a system for spatial audio rendering according to an embodiment of the present disclosure;

FIG. 2A is a conceptual schematic diagram illustrating configuration of a scene information processor according to an embodiment of the present disclosure;

FIG. 2B is a schematic diagram illustrating an example of an implementation of a scene information processor according to an embodiment of the present disclosure;

FIG. 3A is a schematic diagram illustrating an example of an implementation of an artificial reverb unit according to an embodiment of the present disclosure;

FIG. 3B is a schematic diagram illustrating another example of an implementation of an artificial reverb unit according to an embodiment of the present disclosure;

FIG. 4A illustrates a schematic flow diagram of a method for spatial audio rendering according to an embodiment of the present disclosure;

FIG. 4B illustrates a schematic flow diagram of a method for scene information processing according to an embodiment of the present disclosure;

FIG. 5 illustrates a block diagram of some embodiments of an electronic device of the present disclosure;

FIG. 6 illustrates a block diagram of other embodiments of an electronic device of the present disclosure;

FIG. 7 illustrates a block diagram of some embodiments of a chip of the present disclosure.

### DETAILED DESCRIPTION

The technical solutions in the embodiments of the present disclosure will be described clearly and completely with reference to the drawings in the embodiments of the present disclosure, and it is obvious that the embodiments described are only some embodiments of the present disclosure, rather than all embodiments. The following description of at least one exemplary embodiment is in fact merely illustrative and is in no way intended to be any limitation on this disclosure and its application or uses. All other embodiments, which can be obtained by one of ordinary skill in the art on the basis of the embodiments in the present disclosure without making inventive labor, are intended to fall within the scope of protection of the present disclosure.

Relative arrangements, numerical expressions and numerical values of parts and steps set forth in these embodiments do not limit the scope of the present disclosure unless specifically stated otherwise. Meanwhile, it should be understood that for ease of description, a size of each portion shown in the drawings is not drawn in an actual scale. Techniques, methods, and devices known to one of ordinary skill in the related art may not be discussed in detail but the techniques, methods, and devices should be considered as part of the specification where appropriate. In all examples shown and discussed herein, any specific value should be construed as exemplary only and not as limiting. Therefore, other examples of the exemplary embodiments may have different values. It should be noted that: similar reference numbers and letters refer to similar items in the attached drawings, and thus, once a certain item is defined in one drawing, it need not be discussed further in subsequent drawings.

### Simulation of Spatial Audio in a Virtual World

In order to simulate various information given by a real world as much as possible in an immersive virtual environment so that immersion of a user is not broken, high-quality simulation of an influence of a position of a sound on a received binaural signal is required.

In the case where a sound source position and a listener position have been determined in a static environment, the influence can be represented by a head related transfer function (HRTF). The HRTF is a dual channel finite impulse response (FIR) filter. By convolving an original signal with the HRTF of a specified position, a signal heard by a listener when a sound source is at the position can be obtained.

However, one HRTF can only represent a relative position relation between one fixed sound source and one determined listener. When it is needed to render, for example, N sound sources (where N is an integer), N HRTFs are theoretically needed, and 2N convolutions are performed on N original signals. In addition, when the listener rotates, all the N HRTFs need to be updated to correctly render a virtual spatial audio scene. Such processing has a large amount of calculation.

In order to solve the problems of multiple sound sources rendering and listener's three degree of freedom (3 DOF) rotation, there is proposed application of Ambisonics in spatial audio rendering. Ambisonics can be implemented by using spherical harmonics. A basic idea of Ambisonics is to assume that sounds are distributed on one sphere, and a plurality of signal channels pointing to different directions play their respective roles of taking responsibility for part of the sounds in a corresponding direction. An Ambisonics-based spatial audio rendering algorithm is as follows:
(1) setting sampling points in each Ambisonics channel to be 0;
(2) by using a horizontal angle and a pitch angle of the sound source relative to the listener, calculating a weight of each Ambisonics channel;
(3) multiplying the original signal by the weight of each Ambisonics channel and superposing the multiplying result to each channel;
(4) for all the sound sources in the scene, repeating the steps (2) to (3);
(5) setting all sample points of a binaural output signal to be 0;
(6) convolving a signal of each Ambisonics channel with an HRTF for a direction corresponding to the channel, and superposing the convolution result on the binaural output signal; and
(7) repeating the step (6) for all the Ambisonics channels.

In this way, the number of the convolution operations is only related to the number of the Ambisonics channels and is not related to the number of the sound sources, and encoding the sound source into an Ambisonics domain is much faster than the convolution operation. Furthermore, if the listener rotates, all the Ambisonics channels can be rotated accordingly, and the amount of this calculation is also unrelated to the number of sound sources.

In addition to rendering the Ambisonics signal into both ears, the Ambisonics signal can simply be rendered into a speaker array.

### Simulation of an Environment Acoustic Phenomenon in a Virtual World

The environment acoustic phenomenon is ubiquitous in reality. In order to simulate various information given by a real world as much as possible in an immersive virtual environment so that immersion of a user is not broken, high-quality simulation of an influence of a virtual scene on a sound in the scene is required.

In the related art, the simulation of the environment acoustic phenomenon mainly includes the following three methods: finite element analysis-based wave solver, ray tracing, and simplifying a geometry of an environment.

### 1. Finite Element Analysis-Based Wave Solver (Wave Physics Simulation)

Space to be calculated needs to be partitioned into densely arranged cubes called “voxels”. Similar to a concept of a pixel which is used for representing an extremely small area unit on a two-dimensional plane, the voxel may represent an extremely small volume unit in a three-dimensional space. Microsoft's Project Acoustics has applied this algorithm idea. A basic process of this algorithm is as follows:
(1) in a virtual scene, exciting one pulse from within a voxel at a position of a sound source;
(2) in a next time segment, calculating, according to a size of the voxel and whether an adjacent voxel contains a scene shape, pulses of all adjacent voxels of the voxel;
(3) repeating the step (2) multiple times to calculate an acoustic wave field in the scene, wherein the more times the step is repeated, the more accurate the calculated acoustic wave field is;
(4) determining an array of all historical amplitudes on a voxel at a listener position as impulse responses from the sound source to this position in the current scene; and
(5) repeating the above steps (1) to (4) for all sound sources in the scene.

The wave solver-based environment acoustic simulation algorithm can achieve very high spatial accuracy and temporal accuracy as long as the selected voxel is small enough and a duration of the selected time segment is short enough. In addition, the simulation algorithm can be adapted to a scene with any shape and material.

However, this algorithm has a large amount of calculation. In particular, the amount of calculation is inversely proportional to the third power of the size of the voxel and proportional to the duration of the time segment. In a reality application scene, it is almost impossible to calculate wave physics in real time while ensuring reasonable temporal accuracy and spatial accuracy.

Therefore, when real-time rendering of the environment acoustic phenomenon is required, a software developer will choose to pre-render a large number of impulse responses between the sound source and the listener under different position combinations, and parameterize the impulse responses, and when real-time calculation is performed, switch rendering parameters in real time according to different positions of the listener and the sound source. This requires a powerful computing device (e.g., Microsoft uses its own Azure cloud) for pre-rendering calculation, and requires an additional storage space to store a large number of parameters.

As described above, when a change that is not considered in the pre-rendering process occurs in the scene, such a method cannot correctly reflect a change in the scene acoustic characteristic, because a corresponding rendering parameter is not saved.

### 2. Ray Tracing

A core idea of this algorithm is: to find as many sound propagation paths from a sound source to a listener as possible, thereby obtaining an energy direction, a delay, and a filtering characteristic that the path will bring. Such an algorithm is the core of environment acoustic simulation systems of Oculus and Wwise.

The algorithm for finding the propagation path from the sound source to the listener can be simply summed up to the following steps:
(1) by taking a listener position as an origin, emitting into space several rays uniformly distributed on a spherical surface; and
(2) for each ray:
(a) if a vertical distance from a certain sound source to the ray is less than a preset value, marking a current path as an effective path of the sound source and storing the effective path,
(b) when the ray is intersected with a scene, changing the direction of the ray according to preset material information of a triangle where an intersection point is located, to cause the emission of the ray to be continued in the scene, and
(c) repeating the steps (a) and (b) until the number of times of reflection of this ray reaches a preset maximum reflection depth, then returning to the step (2), and performing the processing of the steps (a) to (c) on an initial direction of a next ray.

So far, some path information has been recorded for each sound source. Next, by using this information, an energy direction, a delay, and a filtering characteristic of each path of each sound source can be calculated. This information is collectively referred to as spatial impulse responses between the sound source and the listener. Finally, by auralizing the spatial impulse responses of each sound source, it is possible to simulate a very realistic orientation and distance of the sound source, and feature of the environment in which the sound source and the listener are located. The auralizing of the spatial impulse response includes the following methods.

In a method, by encoding a spatial impulse response into an Ambisonics domain to generate a binaural room impulse response (BRIR) in the Ambisonics domain and convolving a sound source original signal with the BRIR, it is possible to obtain spatial audio with room reflection and reverb.

In another method, by using information of a spatial impulse response, a sound source original signal is encoded into an Ambisonics domain, and then the obtained Ambisonics signal is rendered to a binaural output (binauralizing).

Compared with wave physics simulation, the ray tracing-based environment acoustic simulation algorithm has a much less amount of calculation, and therefore, does not require pre-rendering. In addition, the simulation algorithm can be adapted to a dynamically changing scene (such as a door opening, material changing, roof being knocked away, etc.) and can also be adapted to a scene with any shape.

However, accuracy of such an algorithm strongly depends on the amount of sampling of the original directions of the ray, i.e. requires more rays. However, since complexity of the ray tracing algorithm is O (nlog (n)), more rays are bound to bring an explosively increasing amount of calculation. Moreover, regardless of either the BRIR convolution, or encoding the original signal into the Ambisonics domain, the amount of calculation required is considerable. As the number of sound sources in a scene increases, the amount of calculation will also increase linearly. Overall, this is not very friendly to a mobile device with limited computing power.

### 3. Simplifying a Geometry of an Environment

An idea of this algorithm is: to attempt to find an approximate but much simpler geometry and surface material after a geometry and surface material of a current scene are given, thereby greatly reducing the amount of calculation of environment acoustic simulation. Such a practice is not very common, one example being Google's Resonance engine, which includes the following steps:
(1) in a pre-rendering stage, estimating a room shape of a cubic;
(2) assuming that a sound source and a listener are at a same position, by using a geometric characteristic of the cube, quickly calculating a direct sound and an early reflection sound from the sound source to the listener in the scene by means of a look-up table; and
(3) in the pre-rendering stage, calculating, by using an empirical formula for a reverb duration in the cubic room, a late reverb duration in the current scene, thereby controlling one artificial reverb to simulate a late reverb effect of the scene.

Such an algorithm has a very small amount of calculation and can theoretically simulate an infinite reverb duration without additional CPU and memory overhead.

However, at least from presently disclosed methods, such an algorithm has the following disadvantages: the approximate shape of the scene is calculated in the pre-rendering stage so that it cannot be adapted to a dynamically changing scene (such as a door opening, a material changing, a roof being knocked away, etc.); the sound source and the listener are assumed to be always at the same position, which is highly unrealistic; all scene shapes are assumed to be approximated as cubes with three sides respectively parallel to world coordinates, so that many reality scenes (such as a long and narrow corridor, an inclined staircase, a worn-out and crooked container, etc.) cannot be rendered correctly. In short, the extreme rendering speed of such an algorithm is traded by greatly sacrificing the rendering quality.

The inventors of the present application provide a spatial audio rendering technique that simulates environment acoustics. Advantageously, the use of the technique of the present disclosure can enable an environment acoustic simulation algorithm based on geometry simplification to have a rendering quality close to the ray tracing algorithm on the premise that the rendering speed is not affected so much, thereby enabling real-time and high-quality simulation of a large number of sound sources by using a device with weak computing power.

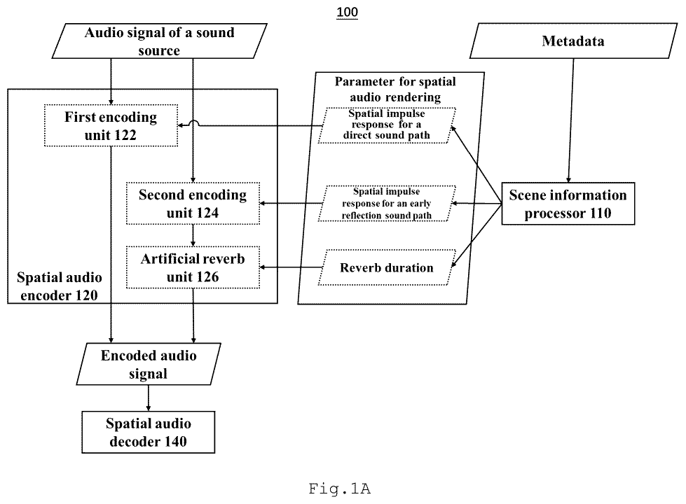

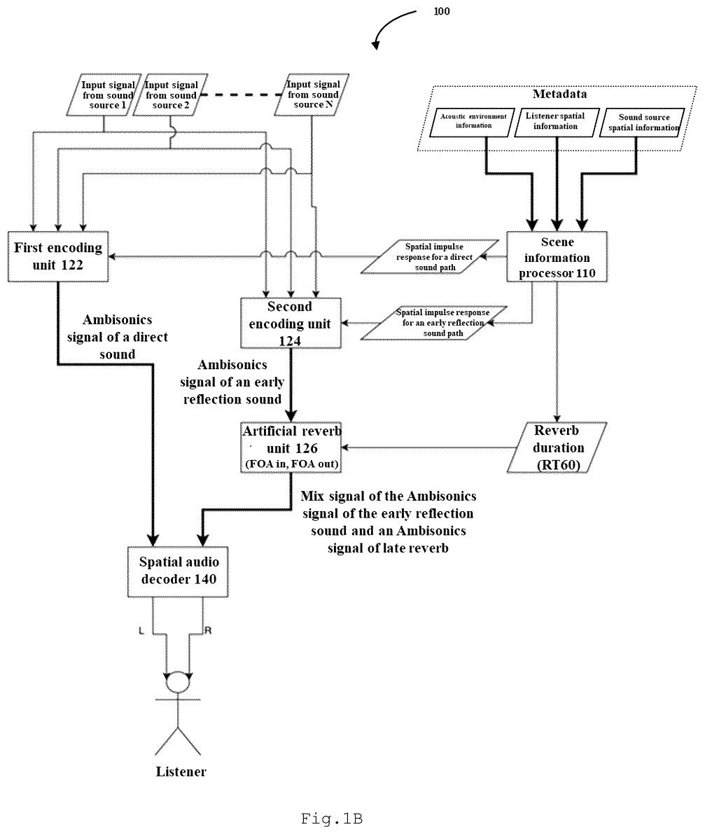

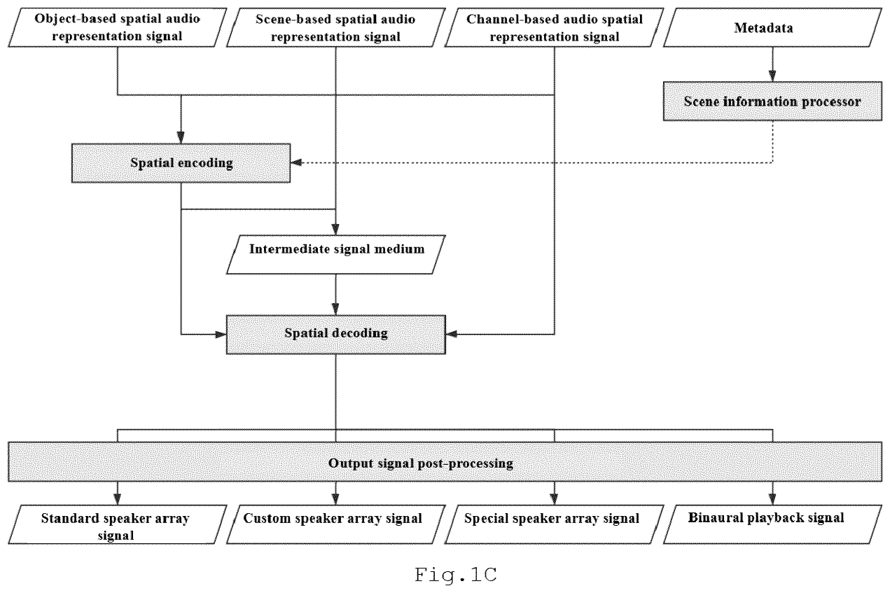

FIG. 1A illustrates a conceptual schematic diagram of a system for spatial audio rendering according to an embodiment of the present disclosure. As shown in FIG. 1A, in the system, a rendering parameter is extracted from metadata describing control information of a rendering technique (such as dynamic position information of sound source and listener, rendered acoustic environment information, e.g., a shape, size, wall material, etc. of a room), thereby rendering an audio signal of a sound source so that it is presented to a user in an appropriate form to satisfy user experience. It should be noted that such a system for spatial audio rendering is applicable to various application scenes, especially simulation of spatial audio in a virtual world.

Core modules of the system 100 for spatial audio rendering and their interrelations will be described in detail below.

### Scene Information Processor 110

As shown in FIG. 1A, the system 100 for spatial audio rendering according to the embodiment of the present disclosure comprises the scene information processor 110.

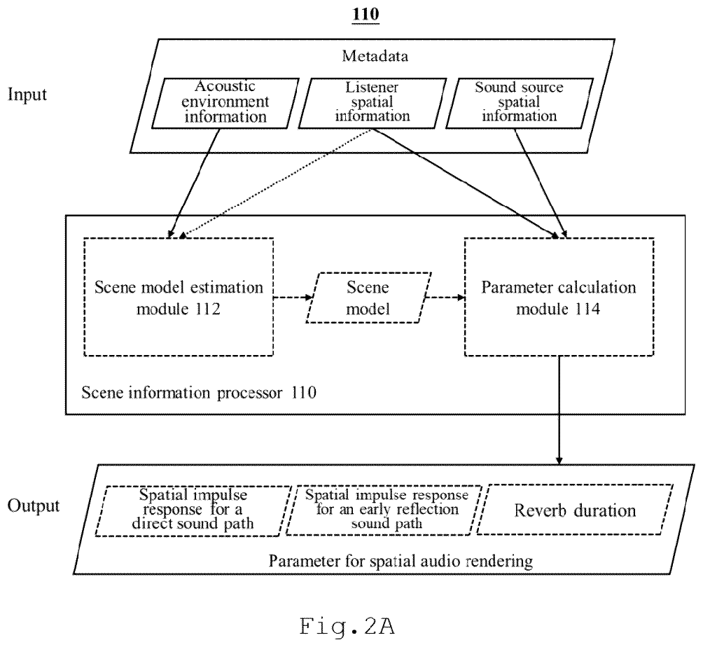

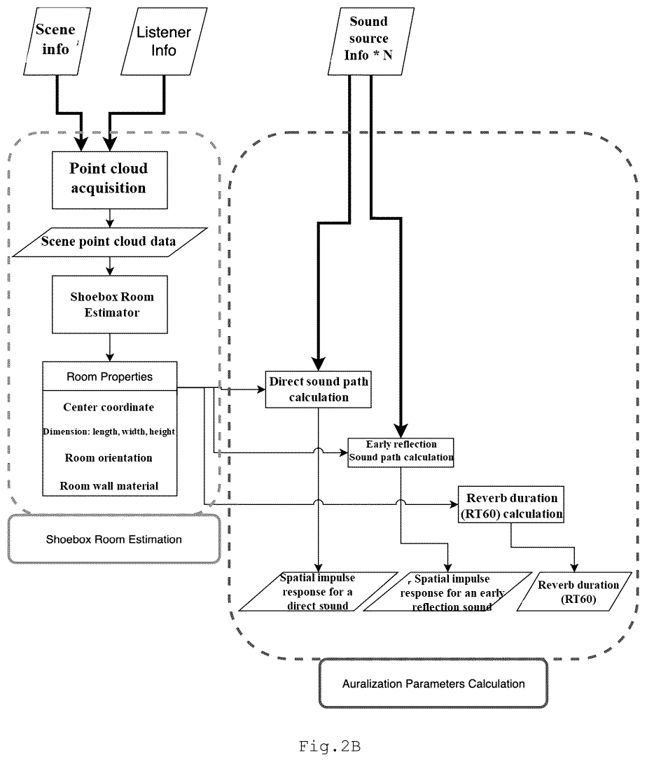

The scene information processor according to the embodiment of the present disclosure will be described in detail below with reference to FIGS. 2A to 2B. FIG. 2A is a block diagram illustrating an example of the scene information processor 110 according to the embodiment of the present disclosure, and FIG. 2B is a schematic diagram illustrating an example of an implementation of the scene information processor 110.

As shown in FIG. 2A, in the embodiment of the present disclosure, the scene information processor 110 is configured to determine, based on metadata (input), a parameter (output) for spatial audio rendering.

In the embodiment of the present disclosure, the metadata may include at least a part of acoustic environment information, listener spatial information, and sound source spatial information.

In some embodiments, the acoustic environment information (also referred to as scene information) may include, but is not limited to, a set of objects forming a scene and acoustic material information of the objects in the set. As an example, a set of objects forming a scene may include three walls, one door, and one tree in front of the door. In some embodiments, the set of the objects may be represented using triangular meshes (e.g., including their vertices and subscript arrays) of shapes of the objects in the set. Furthermore, in some embodiments, the acoustic material information of the object includes, but is not limited to, an absorbance, scatterance, transmittance, etc. of the object. In some embodiments, the listener spatial information may include, but is not limited to, information related to a position, orientation, etc. of the listener, and the sound source spatial information may include, but is not limited to, information related to a position, orientation, etc. of the sound source.

It is noted that in some embodiments, at least some information among the acoustic environment information, the listener spatial information, and the sound source spatial information used may not necessarily be real-time information. Thus, only some of the metadata may be obtained again to determine a new parameter for spatial audio rendering. For example, in the case of relatively slow changes in the acoustic environment information, same acoustic environment information may be used within a preset period of time. For another example, in some embodiments, after having predicted a trend of changes in the listener spatial information, predicted listener spatial information may be used. It is readily understood by those skilled in the art that the present application is not limited to the examples described above.

In the embodiment of the present disclosure, the parameter for spatial audio rendering may indicate a characteristic of sound propagation in a scene in which the listener is located. Here, the characteristic of sound propagation in the scene may be used for simulating an influence of the scene on a sound heard by the listener, including, for example, energy directions, delays, and filtering characteristics of paths of each sound source, and reverb parameter of each frequency band, etc. In some embodiments, the parameter for spatial audio rendering may comprise a set of spatial impulse responses and/or a reverb duration. The set of spatial impulse responses may include a spatial impulse response for a direct sound path and/or a spatial impulse response for an early reflection sound path. Furthermore, in some embodiments, the reverb duration is a function of frequency, so that the reverb duration can also be interpreted as a reverb duration of each frequency band. But those skilled in the art will readily appreciate that the present application is not limited thereto.

In some embodiments, the scene information processor 110 may further include a scene model estimation module 112 and a parameter calculation module 114.

The scene model estimation module 112 may be configured to estimate, based on the acoustic environment information, a scene model approximate to the scene in which the listener is located. Further, in some embodiments, the scene model estimation module 112 may be configured to estimate the scene model based on both the acoustic environment information and the listener spatial information. But those skilled in the art will readily appreciate that the scene model itself is unrelated to the listener spatial information, so that the listener spatial information is not necessary for estimating the scene model.

Furthermore, the parameter calculation module 114 may be configured to calculate, based on at least a part of the estimated scene model, the listener spatial information, and the sound source spatial information, the above parameter for spatial audio rendering.

Specifically, in some embodiments, the parameter calculation module 114 may be configured to calculate the above set of spatial impulse responses based on the estimated scene model, the listener spatial information, and the sound source spatial information. Furthermore, in some embodiments, the parameter calculation module 114 may be configured to calculate the reverb duration based on the estimated scene model. But those skilled in the art will readily appreciate that the present application is not limited thereto. For example, in some embodiments, the listener spatial information and the sound source spatial information may also be used by the parameter calculation module 114 to calculate the reverb duration.

In the example of the implementation of the scene information processor 110 shown in FIG. 2B, the scene model estimation module 112 may be configured to estimate the scene model by using a shoebox room estimation (SRE) algorithm. In the SRE algorithm-based implementation shown in FIG. 2B, the scene model estimated by the scene model estimation module 112 may be a cuboid room model approximate to the current scene in which the listener is located. The cuboid room model can be represented by, for example, room properties. In some embodiments, room properties include, but are not limited to, a center coordinate, dimension (such as length, width, height), orientation, wall material, etc., of a room. Advantageously, the algorithm can in real time and efficiently calculate the cuboid room model approximate to the current scene. But those skilled in the art will readily appreciate that the algorithm for estimating the scene model in the present application is not limited thereto.

As shown in FIG. 2B, shoebox room estimation may be performed based on point cloud data of the scene. In some embodiments, based on the scene information (i.e., the acoustic environment information) and the listener spatial information, a point cloud is acquired by emitting rays around the scene from the position where the listener is located. Alternatively, a point cloud may be obtained by emitting rays around the scene from any reference position. That is, as described above, the listener spatial information is not necessary for the estimation of the environmental model. Furthermore, those skilled in the art will readily appreciate that obtaining the point cloud is also not necessary for estimating the scene model. For example, in some embodiments, other surveying and mapping means, imaging means, and the like may be used in place of the step of obtaining the point cloud.

In the example of the implementation of the scene information processor 110 shown in FIG. 2B, the parameter calculation module 114 may be configured to, based on the estimated room properties (an example of the scene model), calculate an auralization parameter (an example of the parameter for spatial audio rendering), optionally in combination with the listener spatial information and the sound source spatial information involving N sound sources in the metadata.

For example, as shown in FIG. 2B, the parameter calculation module 114 may, based on the estimated room properties, the listener spatial information, and the sound source spatial information, calculate a direct sound path and/or an early reflection sound path, thereby obtaining the corresponding spatial impulse response (s) for the direct sound path and/or the early reflection sound path.

In some embodiments, calculating the direct sound path may be achieved in the following way: connecting a straight line between the listener and the sound source, and determining whether the direct sound path of the sound source is obstructed, through a ray tracer and the inputted acoustic environment information. If the direct sound path is not obstructed, the direct sound path is recorded; otherwise, the direct sound path is not recorded.

In some embodiments, calculating the early reflection sound path may be achieved in the following way: wherein it is assumed that a maximum reflection depth of the early reflection sound is “depth”:
(1) (an optional step) determining whether the sound source is within a range of the cuboid room represented by the current room properties, and if the sound source is not within the range, returning without recording the early reflection sound path of the sound source;
(2) pushing the sound source position into a queue q;
(3) recording a length w of the queue q at this time;
(4) for first w sound source positions of the queue, calculating their mirror positions with respect to 6 walls, and calculating distances do from them to the listener and distances d1 from their mirror positions to the listener. If d1>do, then this mirror position is pushed into the queue; and at the same time, a straight-line path from the mirror position to the listener and a product of an absorbance and a scatterance of a wall through which the path will pass are recorded;
(5) dequeuing the first w elements of the queue q; and
(6) repeating the steps (3) to (6) (depth-1) times.

However, those skilled in the art will readily appreciate that the way of calculating the direct sound path or calculating the early reflection sound path is not limited to the above examples, but it may be self-designed as needed. Furthermore, although the calculation of both the direct sound path and the early reflection sound path are illustrated in the figure, this is merely an example, and the present application is not limited thereto. For example, in some embodiments, only the direct sound path may be calculated.

In addition, as shown in FIG. 2B, the parameter calculation module 114 may also calculate, based on the estimated room properties, a reverb duration (e.g., RT60) of each frequency band of the current scene.

As described above, the scene model estimation module 112 may be configured to estimate the scene model, and the parameter calculation module 114 may, by using the estimated scene model, calculate the corresponding parameter for spatial audio rendering, optionally in combination with positions, orientations, and other information of the sound source and the listener. During the operation of the system 100 for spatial audio rendering, the estimation of the scene model and the calculation of the parameter for spatial audio rendering that are described above may be performed continuously. Advantageously, by providing the continuously updated parameter for spatial audio rendering, response speed and expression power of the system for spatial audio rendering are improved.

It should be noted that the operations of the scene model estimation module 112 and the parameter calculation module 114 do not need to be necessarily synchronous. That is, in a specific implementation of the algorithm, the scene model estimation module 112 and the parameter calculation module 114 may be configured to operate in different threads, that is, the operations of the scene model estimation module 112 and the parameter calculation module 114 may be asynchronous. For example, in view of relatively slow changes in the acoustic environment, an operation period of the scene model estimation module 112 may be much greater than that of the parameter calculation module 114. In such an asynchronous implementation, it is needed to enable secure thread communication between the scene model estimation module 112 and the parameter calculation module 114, thereby transferring the scene model. For example, in some embodiments, lock-free zero copy information transfer may be achieved in a manner of ping pong buffer. But those skilled in the art will readily appreciate that the manner for enabling the secure thread communication is not limited to ping pong buffer, or even to the lock-free zero copy implementation.

### Spatial Audio Encoder 120

Referring back to FIG. 1A, the system 100 for spatial audio rendering according to the embodiment of the present disclosure further comprises a spatial audio encoder 120. As shown in FIG. 1A, the spatial audio encoder 120 is configured to, based on the parameter for spatial audio rendering that is outputted from the scene information processor 110, process the audio signal of the sound source, so as to obtain an encoded audio signal.

In the example of the implementation of the system 100 for spatial audio rendering, as shown in FIG. 1B, the audio signal of the sound source may include input signals from sound sources 1 to N.

In some embodiments, the spatial audio encoder 120 may further include a first encoding unit 122 and/or a second encoding unit 124. The first encoding unit 122 may be configured to perform spatial audio encoding on the audio signal of the sound source by using the spatial impulse response for the direct sound path to obtain a spatial audio encoding signal of a direct sound. The second encoding unit 124 may be configured to perform spatial audio encoding on the audio signal of the sound source by using the spatial impulse response for the early reflection sound path to obtain a spatial audio encoding signal of an early reflection sound. Although both the first encoding unit 122 and the second encoding unit 124 are illustrated in the figure, this is only an example and the present application is not limited thereto. For example, in some embodiments, the first encoding unit 122 may be included.

In some embodiments, the spatial audio encoding may use Ambisonics. Thus, each spatial audio encoding signal may be an Ambisonics-type audio signal. The Ambisonics-type audio signal may include first order Ambisonics (FOA), higher order Ambisonics (HOA), and the like.

For example, in the example of the implementation of the system 100 for spatial audio rendering shown in FIG. 1B, the first encoding unit 122 may be configured to encode the audio signal of the sound source by using the spatial impulse response for the direct sound path, to calculate an Ambisonics signal of the direct sound. That is, an input to the first encoding unit 122 may include the audio signal of the sound source that is formed by input signals of sound sources 1 to N and the spatial impulse response for the direct sound path. By encoding the audio signal of the sound source into the Ambisonics domain using the spatial impulse response for the direct sound path, an output of the first encoding unit 122 may include the Ambisonics signal of the direct sound for the audio signal of the sound source.

Similarly, the second encoding unit 124 may be configured to encode the audio signal of the sound source by using the spatial impulse response for the early reflection sound path, to calculate an Ambisonics signal of the early reflection sound. That is, an input to the second encoder 124 may include the audio signal of the sound source that is formed by the input signals of the sound sources 1 to N and the spatial impulse response for the early reflection sound path. By encoding the audio signal of the sound source into the Ambisonics domain using the spatial impulse response for the early reflection sound path, an output of the second encoding unit 124 may include the Ambisonics signal of the early reflection sound of the audio signal of the sound source.

In this way, by encoding the audio signal of the sound source into the Ambisonics domain using the set of spatial impulse responses, the sum of the Ambisonics signals on all the spatialized paths after the audio signal of the sound source reaches the listener through all the propagation paths described by the set of spatial impulse responses is obtained.

As an example, in some embodiments, encoding the sound source signal in the encoding unit may be achieved in the following way:

for each sound source, in view of a delay in propagation of sound in space, an audio signal of the sound source is written into one delayer. According to a result obtained by the scene information processor 110, each sound source will have one or more propagation paths to reach the listener, so that according to a length of each path, a time t1 required for the sound source to reach the listener through the path may be calculated. The encoding unit obtains, from the delayer of the sound source, an audio signal s of the sound source time t1 earlier, performs filtering E according to path energy intensity, and performs Ambisonics coding on the signal in combination with a direction θ in which the path arrives at the listener, to convert the signal into an HOA signal S_{N}, where N is a total number of channels for the HOA signal. Optionally, a direction of the path with respect to a coordinate system may be used here, rather than the direction θ in which the path arrives at the listener, so as to obtain a target acoustic field signal by multiplication with a rotation matrix in a subsequent step. A typical encoding method is as follows, where Y_{N} is spherical harmonics of a corresponding channel:

$${s}_{N} = E ( s ( t - {t}_{1} ) ) {Y}_{N} ( θ )$$

In some embodiments, the encoding operation may be performed in a time domain or a frequency domain. In addition, the encoding unit may further perform encoding using at least one of near-field compensation and source spread according to the length of the spatial propagation path, so as to enhance the effect.

Finally, the HOA signal obtained by the conversion for each propagation path of each sound source may be weighted and superimposed according to a weight of the sound source. The result of the superposition is a representation of the direct sounds and early reflection sounds of the audio signals of all the sound sources in the Ambisonics domain.

Furthermore, in some embodiments, the spatial audio encoder 120 may further comprise an artificial reverb unit 126.

In some embodiments, the artificial reverb unit 126 may be configured to, based on the reverb duration and the audio signal of the sound source, determine a mix signal.

Specifically, in some embodiments, the system may include a reverb preprocessing unit, configured to determine a reverb input signal according to a distance between the listener and the sound source and the audio signal of the sound source. Thus, the artificial reverb unit 126 may be configured to, based on the reverb duration, perform artificial reverb processing on the reverb input signal to obtain the above mix signal. In some embodiments, the reverb preprocessing unit may be included in the artificial reverb unit 126, but this is merely an example and the present application is not limited thereto.

Alternatively, in other embodiments, the artificial reverb unit 126 may be configured to, based on the reverb duration, perform artificial reverb processing on the spatial audio encoding signal of the early reflection sound, to output a mix signal of the spatial audio encoding signal of the early reflection sound and a spatial audio encoding signal of late reverb.

For example, in the example of the implementation of the system 100 for spatial audio rendering shown in FIG. 1B, an input to the artificial reverb unit 126 may include the Ambisonics signal of the early reflection sound and the reverb duration (e.g., RT60) of each frequency band. Thus, an output of the artificial reverb unit 126 may include a mix signal of the Ambisonics signal of the early reflection sound and an Ambisonics signal of the late reverb. That is, the artificial reverb unit 126 may output an Ambisonics signal with the late reverb.

In some embodiments, the artificial reverb processing may be implemented in the artificial reverb unit 126 by using a Feedback Delay Network (FDN) algorithm, which has advantages of having an echo density that grows over time and an easily and flexibly adjustable number of input and output channels.

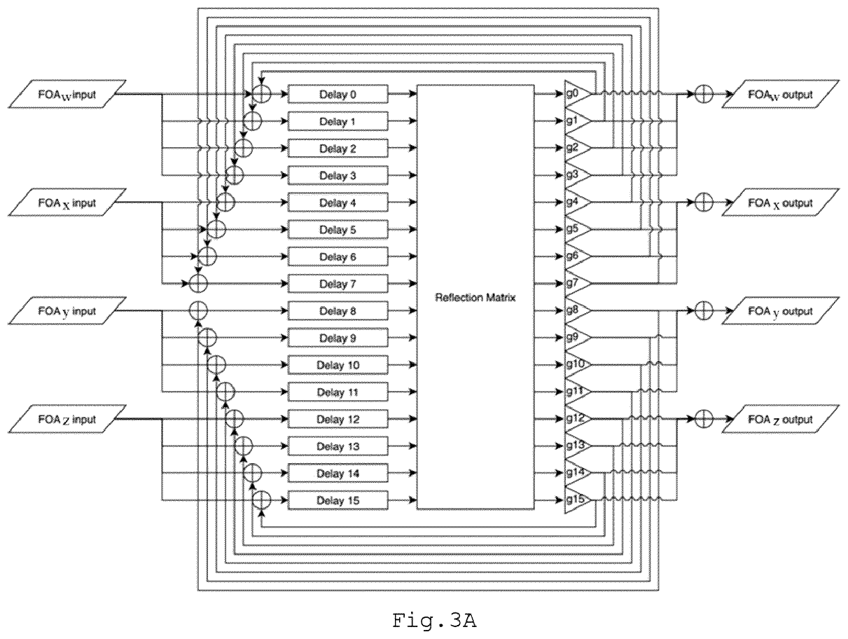

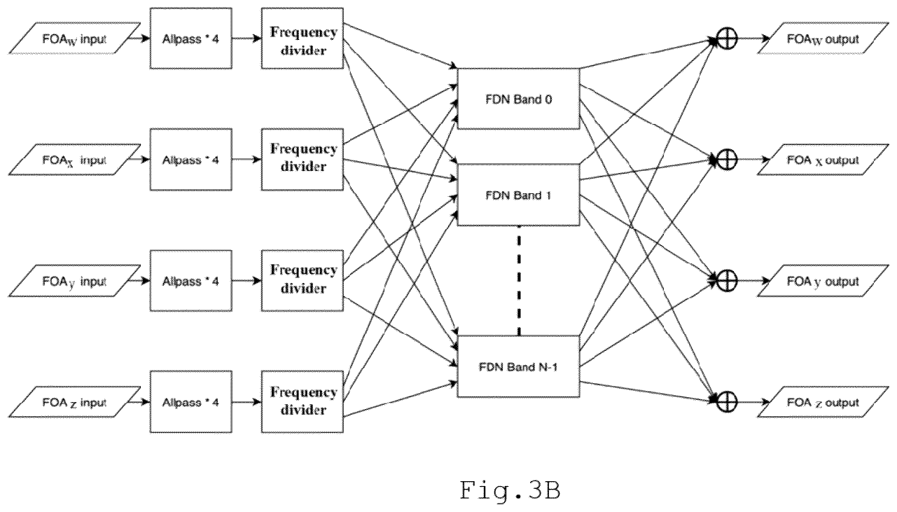

As an example, in some embodiments, an example of an implementation of the artificial reverb unit 126 as shown in FIGS. 3A to 3B may be used.

FIG. 3A illustrates an example of configuration of a 16th order FDN reverberator (one frequency band) receiving FOA input and FOA output according to an embodiment of the present disclosure.

Delays 0 to 15 are fixed length delays. In some embodiments, the delays 0 to 15 may be set by randomly choosing numbers that are mutually prime numbers within a range of, for example, 30 ms to 50 ms, and taking an approximate positive integer of a product of the numbers and a sampling rate. A reflection matrix may be, for example, a 16×16 Householder matrix. g0 to g15 are a feedback gain after each delay. According to an inputted reverb duration (e.g., RT60), a specific value of g can be calculated as follows:

$$g ( n ) = 10 \frac{- 3 * delay ( n )}{R T 60} , n ∈ [ 0 , 15 ]$$

In addition, in some embodiments, if a multi-band absorbance is used in implementing the FDN algorithm, the reverb needs to be changed to be in a multi-band adjustable form, for which reference can be made to an implementation shown in FIG. 3B.

FIG. 3B illustrates an example of configuration of an FDN reverberator (multiple frequency bands) receiving FOA input and FOA output according to an embodiment of the present disclosure.

“All-pass * 4” represents 4 cascaded Schroeder all-pass filters; the number of samples of delay for each filter can be set by randomly choosing numbers that are mutually prime numbers within a range of, for example, 5 ms to 10 ms, and taking an approximate positive integer of a product of the numbers and a sampling rate; and g of each filter may be set to 0.7.

It should be noted that the above implementations of the artificial reverb unit all receive the FOA input and the FOA output. Advantageously, such implementation can maintain the an directionality of the early reflection sound.

It will be readily understood by those skilled in the art that the above examples are only used for illustrating that alternative implementations exist and do not mean that only such an implementation can be used, and the implementation of the artificial reverb unit is not limited to the above examples.

### Spatial Audio Decoder 140

Referring back to FIG. 1A, the system 100 for spatial audio rendering according to the embodiment of the present disclosure further includes a spatial audio decoder 140. As shown in FIG. 1A, the spatial audio decoder 140 is configured to perform spatial decoding on the encoded audio signal, so as to obtain a decoded audio signal.

In some embodiments, the encoded audio signal inputted into the spatial audio decoder 140 includes the spatial audio encoding signal of the direct sound and the mix signal. The mix signal includes the spatial audio encoding signal of the late reverb and/or the spatial audio encoding signal of the early reflection sound. That is, the output signals of the first encoding unit 122 and the artificial reverb unit 126 are inputted into the spatial audio decoder 140.

For example, in the example of the implementation of the system 100 for spatial audio rendering shown in FIG. 1B, the signal inputted into the spatial audio decoder 140 includes the Ambisonics signal of the direct sound and the mix signal of the Ambisonics signal of the early reflection sound and the Ambisonics signal of the late reverb.

In some embodiments, an input to the spatial audio decoder 140 may also include other signals than the encoded audio signal, for example, a transparent transmission signal (such as a non-narrative channel signal).

Optionally, in some embodiments, before performing spatial decoding by the spatial audio decoder 140, other processing can be performed on the encoded audio signal. For example, in the example of the implementation of the system 100 for spatial audio rendering shown in FIG. 1B, the spatial audio decoder 140 may, before performing spatial decoding, multiply the Ambisonics signal and a rotation matrix as needed according to rotation information in the metadata, so as to obtain a rotated Ambisonics signal.

In some embodiments, according to different requirements, the spatial audio decoder 140 may output a variety of signals, including but not limited to different kinds of signals adapted to speakers and earphones.

In some embodiments, the spatial audio decoder 140 may, based on a playback type of a user application scene, perform spatial decoding, so as to obtain an audio signal suitable for playback in a user playback application scene. Some embodiments of a method for performing spatial decoding based on the playback type of the user application scene are listed below, but those skilled in the art will readily appreciate that the decoding method is not limited thereto.

### 1. Standard Speaker Array Spatial Decoding

In some embodiments, a speaker array is a speaker array defined in a standard, such as a 5.1 speaker array. In this case, a decoding matrix coefficient will be built into a decoder, so that a playback signal L can be obtained by multiplying the Ambisonics signal and a decoding matrix.

$$L = D {S}_{N}$$

where L is a speaker array signal, D is the decoding matrix, and S_{N} is an HOA signal.

Meanwhile, according to the definition of the standard speaker, a transparent transmission signal can be converted into the speaker array by means of VBAP and the like.

### 2. Custom Speaker Array Spatial Decoding

In some embodiments, a speaker array is an array of custom speakers which typically have a spherical, hemispherical or rectangular design, so that the listener may be surrounded or semi-surrounded. In this case, the spatial audio decoder 140 may calculate a decoding matrix according to arrangement of the custom speakers, and a required input includes an azimuth angle and a pitch angle of each speaker, or three-dimensional coordinate values of the speaker. The speaker decoding matrix may be calculated by means of a Sampling Ambisonics Decoder (SAD), Mode Matching decoder (MMD), Energy preserved Ambisonics Decoder (EPAD), All Round Ambisonics Decoder (AllRAD), etc.

### 3. Special Speaker Array Spatial Decoding

In some embodiments, a speaker array is a sound bar or a more special speaker array. In this case, the speaker manufacturer is required to provide a correspondingly designed decoding matrix. The system provides a setting interface for the decoding matrix and performs decoding processing by formulating the decoding matrix.

### 4. Earphone (Binaural Playback) Spatial Decoding

In some embodiments, the user application environment is an earphone playback environment. As an example, there are several alternative decoding modes for the earphone's playback environment.

One mode is to directly decode the Ambisonics signal into a binaural signal, for which typical methods include least squares (LS), magnitude least squares (Magnitude LS), spatial resampling (SPR), and the like. For a transparent transmission signal, it is typically a binaural signal, so that playback can be performed directly.

The other mode is to perform indirect rendering, i.e., firstly using a speaker array, and then performing HRTF convolution according to positions of speakers to perform virtualization processing on the speakers.

Advantageously, the use of the technique of the present disclosure can enable an environment acoustic simulation algorithm based on geometry simplification to have a rendering quality close to the ray tracing algorithm on the premise that rendering speed is not affected so much, thereby enabling real-time and high-quality simulation of a large number of sound sources by using a device with relative weak computing power.

FIG. 1C illustrates a simplified schematic diagram of an application example of a system 100 for spatial audio rendering according to an embodiment of the present disclosure.

In the application example shown in FIG. 1C, a spatial encoding part corresponds to the spatial audio encoder in the above embodiment, a spatial decoding part corresponds to the spatial audio decoder in the above embodiment, and a scene information processor is configured to, based on metadata, determine a parameter for spatial encoding (corresponding to the parameter for spatial audio rendering in the above embodiment).

Furthermore, an object-based spatial audio representation signal corresponds to the audio signal of the sound source in the above embodiment. The spatial encoding part is configured to, based on the parameter outputted from the scene information processor, process the object-based spatial audio representation signal, so as to obtain an encoded audio signal as a part of an intermediate signal medium. It should be noted that a scene-based spatial audio representation signal and a channel-based spatial audio representation signal may be directly taken as a specific spatial format signal for direct transmission to the spatial decoder, without performing the aforementioned spatial audio processing.

According to different requirements, the spatial decoding part may output a variety of signals, including but not limited to different kinds of signals adapted to various speakers and earphones.

It should be noted that the components of the system for spatial audio rendering as described above are merely logical modules divided according to the specific functions implemented by the components, and are not used for limiting the specific implementations, for example, they may be implemented in software, hardware, or a combination of software and hardware. In practical implementations, the above units may be implemented as independent physical entities, or may also be implemented by a single entity (for example, a processor (CPU or DSP, etc.), an integrated circuit, etc.), for example, an encoder, a decoder, etc. may be implemented using a chip (such as an integrated circuit module including a single wafer), a hardware component, or a complete product. In addition, components indicated by dashed lines in the drawings indicate that these components can exist, but do not need to actually exist, and the operations/functions implemented by them can be implemented by the processing circuit itself.

Furthermore, optionally, the system 100 for spatial audio rendering may also include other components not shown, such as an interface, memory, communication unit, etc. As an example, the interface and/or communication unit may be used for receiving an inputted audio signal to be rendered, and may also output a finally generated audio signal to a playback device in a playback environment for playback. As an example, the memory may store various data, information, programs, etc. used in spatial audio rendering and/or generated in the process of the spatial audio rendering. The memory may include, but is not limited to, random access memory (RAM), dynamic random access memory (DRAM), static random access memory (SRAM), read-only memory (ROM), flash memory.

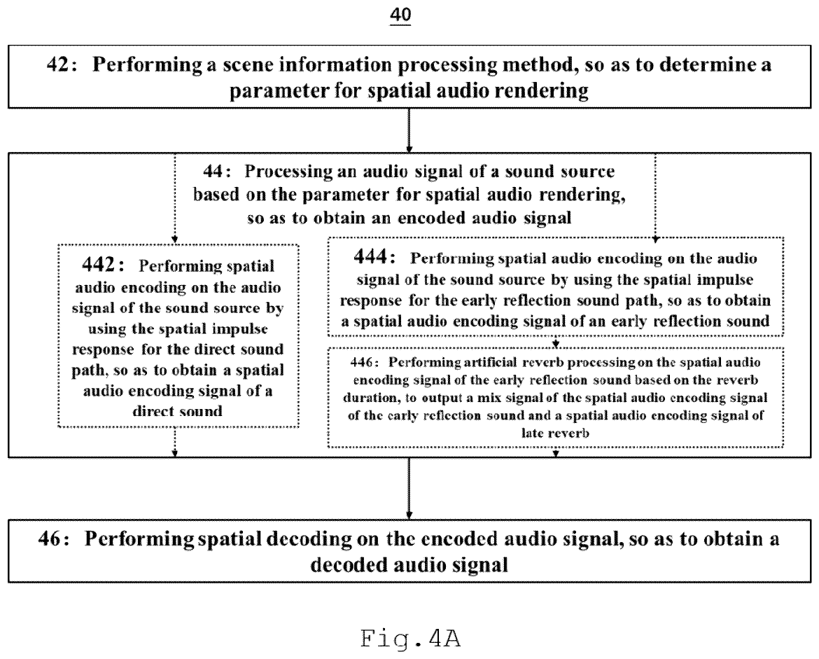

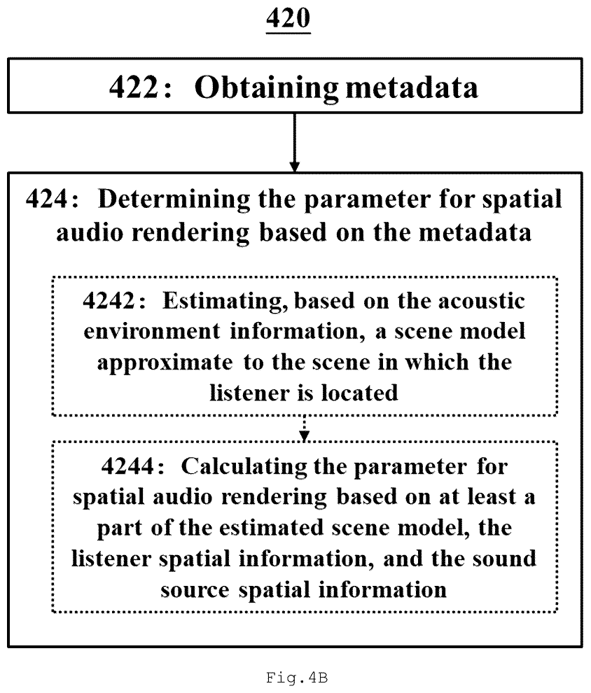

FIG. 4A illustrates a schematic flow diagram of a method 40 for spatial audio rendering according to an embodiment of the present disclosure; and FIG. 4B illustrates a schematic flow diagram of a scene information processing method 420 according to an embodiment of the present disclosure. The corresponding contents described above with respect to the scene information processor and the system for spatial audio rendering are also adapted to this portion, so that the description thereof will not be repeated here.

As shown in FIG. 4A, the method 40 for spatial audio rendering according to the embodiment of the present disclosure comprises the following steps of: in step 42, performing a scene information processing method 420, to determine a parameter for spatial audio rendering; in step 44, processing an audio signal of a sound source based on the parameter for spatial audio rendering, to obtain an encoded audio signal; and in step 46, performing spatial decoding on the encoded audio signal, to obtain a decoded audio signal.

As shown in FIG. 4B, the scene information processing method 420 according to the embodiment of the present disclosure comprises the following steps of: in step 422, obtaining metadata, wherein the metadata includes at least a part of acoustic environment information, listener spatial information, and sound source spatial information; and in step 424, determining the parameter for spatial audio rendering based on the metadata, wherein the parameter for spatial audio rendering indicates a characteristic of sound propagation in a scene in which a listener is located.

In some embodiments, the step 424 may further include the following sub-steps of: in sub-step 4242, estimating, based on the acoustic environment information, a scene model approximate to the scene in which the listener is located; and in sub-step 4244, calculating the parameter for spatial audio rendering based on at least a part of the estimated scene model, the listener spatial information, and the sound source spatial information.

In some embodiments, the parameter for spatial audio rendering may include a set of spatial impulse responses and/or a reverb duration. The set of spatial impulse responses may include a spatial impulse response for a direct sound path and/or a spatial impulse response for an early reflection sound path. Furthermore, in some embodiments, the reverb duration is related to a frequency, so that the reverb duration can also be interpreted as a reverb duration of each frequency band. But those skilled in the art will readily appreciate that the present application is not limited thereto.

In some embodiments, the calculating the parameter for spatial audio rendering includes calculating the set of spatial impulse responses based on the estimated scene model, the listener spatial information, and the sound source spatial information. Furthermore, in some embodiments, the calculating the parameter for spatial audio rendering includes calculating the reverb duration based on the estimated scene model.

In some embodiments, the sub-step 4242 of estimating the scene model and the sub-step 4244 of calculating the parameter for spatial audio rendering are performed asynchronously.

Referring back to FIG. 4A, in some embodiments, the step 44 may further include the following sub-steps of: in sub-step 442, performing spatial audio encoding on the audio signal of the sound source by using the spatial impulse response for the direct sound path, so as to obtain a spatial audio encoding signal of a direct sound; and in sub-step 444, performing spatial audio encoding on the audio signal of the sound source by using the spatial impulse response for the early reflection sound path, so as to obtain a spatial audio encoding signal of an early reflection sound. But this is merely an example and the present application is not limited thereto, for example, the step 44 may include only the sub-step 442.

Moreover, in some embodiments, the step 44 may further include sub-step 446. In the sub-step 446, based on the reverb duration, artificial reverb processing is performed on the spatial audio encoding signal of the early reflection sound to output a mix signal of the spatial audio encoding signal of the early reflection sound and a spatial audio encoding signal of late reverb.

Alternatively, in some embodiments, in the sub-step 446, based on the reverb duration and the audio signal of the sound source, the above mix signal is determined. Specifically, the sub-step 446 includes: determining a reverb input signal according to a distance between the listener and the sound source and the audio signal of the sound source; and performing, based on the reverb duration, artificial reverb processing on the reverb input signal to obtain the above mix signal.

Thus, in some embodiments, the encoded audio signal to be subjected to spatial audio decoding in the step 46 includes the spatial audio encoding signal of the direct sound and the above mix signal. The mix signal includes the spatial audio encoding signal of the late reverb and/or the spatial audio encoding signal of the early reflection sound.

Those skilled in the art will readily appreciate that the above-described features of the system for spatial audio rendering according to the present disclosure are also applicable to relevant contents in the method for spatial audio rendering according to the present disclosure, so that the description thereof will not be repeated here.

Although not shown, the method for spatial audio rendering according to the present disclosure may further include other steps to perform the processes/operations described previously, which will not be described in detail here. It should be noted that the method for spatial audio rendering according to the present disclosure and the steps therein may be performed by any suitable device, for example, a processor, an integrated circuit, a chip, etc., for example, they may be performed by the aforementioned audio rendering system and the modules therein, and this method may also be embodied in a computer program, instructions, a computer program medium, a computer program product, etc. for implementation.

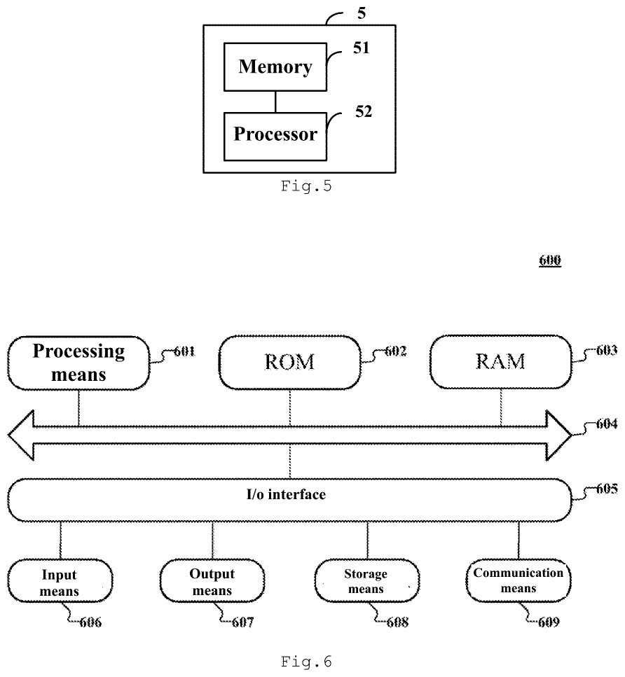

FIG. 5 illustrates a block diagram of some embodiments of an electronic device of the present disclosure.

As shown in FIG. 5, the electronic device 5 of the embodiment comprises: a memory 51 and a processor 52 coupled to the memory 51, the processor 52 being configured to perform, based on instructions stored in the memory 51, the method for spatial audio rendering in any of the embodiments of the present disclosure.

The memory 51 may include, for example, a system memory, a fixed nonvolatile storage medium, and the like. The system memory has thereon stored, for example, an operating system, an application, a boot loader, a database, another program, and the like.

Reference is made below to FIG. 6, which illustrates a schematic structural diagram of an electronic device suitable for implementing an embodiment of the present disclosure. The electronic device in the embodiment of the present disclosure may include, but is not limited to, a mobile terminal such as a mobile phone, notebook computer, digital broadcast receiver, PDA (Personal Digital Assistant), PAD (Tablet), PMP (Portable Multimedia Player), and vehicle-mounted terminal (e.g., vehicle-mounted navigation terminal), and a fixed terminal such as a digital TV and desktop computer. The electronic device shown in FIG. 6 is only an example, and should not bring any limitation to the functions and the scope of use of the embodiments of the present disclosure.

FIG. 6 illustrates a block diagram of some other embodiments of an electronic device of the present disclosure.

As shown in FIG. 6, the electronic device may include a processing means (e.g., a central processing unit, a graphics processing unit, etc.) 601 that may perform various appropriate actions and processes according to a program stored in a read-only memory (ROM) 602 or a program loaded from a storage means 608 into a random access memory (RAM) 603. In the RAM 603, various programs and data required for the operation of the electronic device are also stored. The processing means 601, the ROM 602, and the RAM 603 are connected to each other via a bus 604. An input/output (I/O) interface 605 is also connected to the bus 604.

Generally, the following means may be connected to the I/O interface 605: an input means 606 including, for example, a touch screen, touch pad, keyboard, mouse, image sensor, microphone, accelerometer, gyroscope, and the like; an output means 607 including, for example, a liquid crystal display (LCD), speaker, vibrator, and the like; the storage means 608 including, for example, a magnetic tape, hard disk, and the like; and a communication means 609. The communication means 609 may allow the electronic device to communicate with other devices wirelessly or by wire to exchange data. While FIG. 6 illustrates the electronic device having various means, it should be understood that not all the illustrated means are required to be implemented or provided. More or fewer means may be alternatively implemented or provided.

According to an embodiment of the present disclosure, the processes described above with reference to the flow diagrams may be implemented as a computer software program. For example, an embodiment of the present disclosure comprises a computer program product comprising a computer program carried on a computer-readable medium, the computer program comprising program code for performing the method illustrated in the flow diagrams. In such an embodiment, the computer program may be downloaded and installed from a network via the communication means 609, or installed from the storage means 608, or installed from the ROM 602. The computer program, when executed by the processing means 601, performs the above functions defined in the method of embodiments of the present disclosure.

In some embodiments, there is further provided a chip, comprising: at least one processor and an interface, the interface being configured to provide computer-executable instructions to the at least one processor, and the at least one processor being configured to execute the computer-executable instructions to implement the scene information processing method or the method for spatial audio rendering of any of the embodiments above.

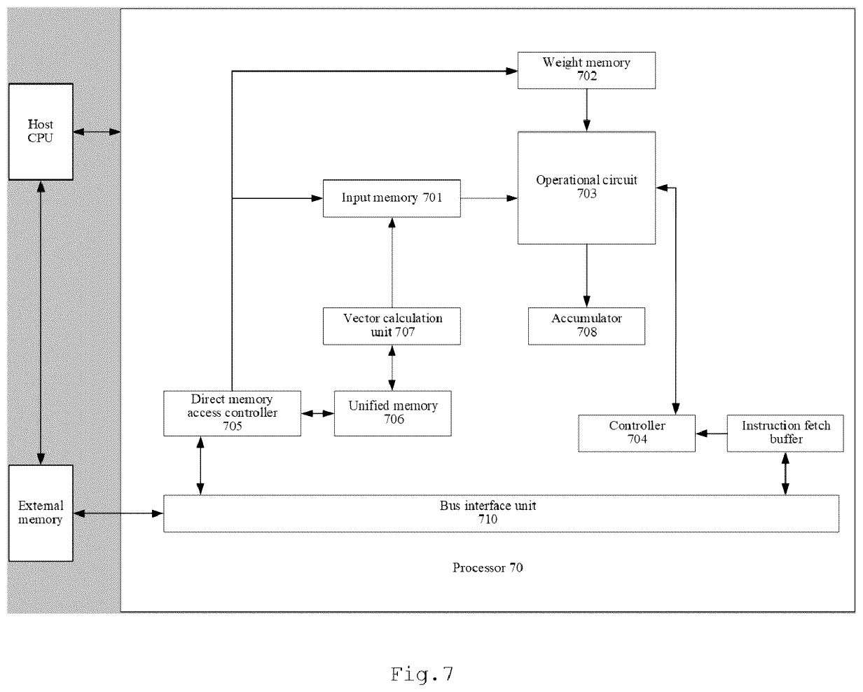

FIG. 7 illustrates a block diagram of some embodiments of a chip of the present disclosure.

As shown in FIG. 7, a processor 70 of the chip is mounted as a coprocessor onto a host CPU, by which tasks are allocated. A core portion of the processor 70 is an operational circuit, and a controller 704 controls the operational circuit 703 to extract data in a memory (weight memory or input memory) and perform an operation.

In some embodiments, a plurality of process engines (PEs) are included inside the operational circuit 703. In some embodiments, the operational circuit 703 is a two-dimensional systolic array. The operational circuit 703 may also be a one-dimensional systolic array or other electronic circuits capable of performing mathematical operations such as multiplication and addition. In some embodiments, the operational circuit 703 is a general-purpose matrix processor.

For example, assume that there are an input matrix A, a weight matrix B, and an output matrix C. The operational circuit fetches data corresponding to the matrix B from the weight memory 702 and buffers the data on each PE in the operational circuit. The operational circuit fetches matrix A data from the input memory 701 to perform matrix operation with the matrix B, and a partial or final result of the obtained matrix is stored in an accumulator 708.

A vector calculation unit 707 may perform further processing, such as vector multiplication, vector addition, exponential operation, logarithmic operation, magnitude comparison, etc., on the output of the operational circuit.

In some embodiments, the vector calculation unit 707 can store a vector of the processed output into a unified buffer 706. For example, the vector calculation unit 707 may apply a non-linear function to an output of the operational circuit 703, such as a vector of an accumulation value, to generate an activation value. In some embodiments, the vector calculation unit 707 generates a normalized value, a merging value, or both. In some embodiments, the vector of the processed output can be used as an activation input to the operational circuit 703, for example, for use in a subsequent layer in a neural network.

The unified memory 706 is configured to store input data and output data.

A direct memory access controller 705 (DMAC) transfers the input data in an external memory to the input memory 701 and/or the unified memory 706, stores weight data in the external memory into the weight memory 702, and stores data in the unified memory 706 into the external memory.

A bus interface unit (BIU) 710 is configured to enable interaction between the host CPU, the DMAC, and an instruction fetch buffer 709 through a bus.

The instruction fetch buffer 709 connected to the controller 704 is configured to store instructions used by the controller 704.

The controller 704 is configured to call instructions buffered in the instruction fetch buffer 709, to control the working process of the operation accelerator.

Generally, the unified memory 706, the input memory 701, the weight memory 702, and the instruction fetch buffer 709 are all on-chip memories, and the external memory is a memory external to the NPU, and the external memory may be a double data rate synchronous dynamic random access memory (DDR SDRAM), a high bandwidth memory (HBM), or other readable and writable memories.

In some embodiments, there is further provided a computer program, comprising: instructions which, when executed by a processor, cause the processor to perform the scene information processing method or the method for spatial audio rendering of any of the above embodiments.

Those skilled in the art should understand that the present disclosure may take a form of an entire hardware embodiment, an entire software embodiment, or an embodiment combining software and hardware aspects. When implemented in software, the above embodiments may be wholly or partially implemented in a form of a computer program product. The computer program product includes one or more computer instructions or computer programs. When the computer instructions or computer programs are loaded or executed on a computer, the processes or functions according to the embodiments of the present application are wholly or partially generated. The computer may be a general-purpose computer, a special-purpose computer, a computer network, or other programmable devices. Furthermore, the present disclosure may take a form of a computer program product implemented on one or more computer-usable non-transitory storage media (including, but not limited to, a disk memory, CD-ROM, optical memory, etc.) having computer-usable program code embodied therein.

Although some specific embodiments of the present disclosure have been described in detail by examples, it should be understood by those skilled in the art that the above examples are for illustration only and are not intended to limit the scope of the present disclosure. It should be appreciated by those skilled in the art that modifications can be made to the above embodiments without departing from the scope and spirit of the present disclosure. The scope of the present disclosure is defined by the attached claims.

What is claimed is:

1. A method for spatial audio rendering, comprising:
determining a parameter for spatial audio rendering based on metadata, wherein the metadata comprises at least a part of acoustic environment information, listener spatial information, and sound source spatial information, and the parameter for spatial audio rendering indicates a characteristic of sound propagation in a scene in which a listener is located;
processing an audio signal of a sound source based on the parameter for spatial audio rendering, so as to obtain an encoded audio signal; and
performing spatial decoding on the encoded audio signal, so as to obtain a decoded audio signal.

2. The method according to claim 1, wherein the determining the parameter for spatial audio rendering comprises:
estimating, based on the acoustic environment information, a scene model approximate to the scene where the listener is located; and
calculating the parameter for spatial audio rendering based on at least a part of the estimated scene model, the listener spatial information, and the sound source spatial information.

3. The method according to claim 2, wherein
the parameter for spatial audio rendering comprises a set of spatial impulse responses and/or a reverb duration.

4. The method according to claim 3, wherein
the set of spatial impulse responses comprises a spatial impulse response for a direct sound path and/or a spatial impulse response for an early reflection sound path.

5. The method according to claim 3, wherein the reverb duration is calculated based on the estimated scene model.

6. The method according to claim 3, wherein the set of spatial impulse responses is calculated based on the estimated scene model, the listener spatial information, and the sound source spatial information.

7. The method according to claim 3, wherein the encoded audio signal comprises:
a spatial audio encoding signal of a direct sound, and/or a mix signal,
wherein the mix signal comprises a spatial audio encoding signal of late reverb and/or a spatial audio encoding signal of an early reflection sound.

8. The method according to claim 7, wherein the spatial audio encoding signal of the direct sound is obtained by performing spatial audio encoding on the audio signal of the sound source by using the spatial impulse response for the direct sound path.

9. The method according to claim 7, wherein the mix signal is obtained by:
determining, based on the reverb duration and the audio signal of the sound source, the mix signal.

10. The method according to claim 9, wherein the determining, based on the reverb duration and the audio signal of the sound source, the mix signal comprises:
determining, according to a distance between the listener and the sound source and the audio signal of the sound source, a reverb input signal; and
performing, based on the reverb duration, artificial reverb processing on the reverb input signal to obtain the mix signal.

11. The method according to claim 7, wherein the mix signal is obtained by:
performing spatial audio encoding on the audio signal of the sound source by using the spatial impulse response for the early reflection sound path, to obtain the spatial audio encoding signal of the early reflection sound; and
performing, based on the reverb duration, artificial reverb processing on the spatial audio encoding signal of the early reflection sound, to obtain the mix signal mixed by the spatial audio encoding signal of the early reflection sound and the spatial audio encoding signal of the late reverb.

12. A chip, comprising:
at least one processor and an interface, the interface being configured to provide computer-executable instructions to the at least one processor, the at least one processor being configured to perform the computer-executable instructions to implement the method for spatial audio rendering according to claim 1.

13. An electronic device, comprising:
a memory; and
a processor coupled to the memory, the processor being configured to perform, based on instructions stored in the memory, the steps of:
determining a parameter for spatial audio rendering based on metadata, wherein the metadata comprises at least a part of acoustic environment information, listener spatial information, and sound source spatial information, and the parameter for spatial audio rendering indicates a characteristic of sound propagation in a scene in which a listener is located;
processing an audio signal of a sound source based on the parameter for spatial audio rendering, so as to obtain an encoded audio signal; and
performing spatial decoding on the encoded audio signal, so as to obtain a decoded audio signal.

14. The electronic device according to claim 13, wherein the step of determining the parameter for spatial audio rendering further comprises the steps of:
estimating, based on the acoustic environment information, a scene model approximate to the scene where the listener is located; and
calculating the parameter for spatial audio rendering based on at least a part of the estimated scene model, the listener spatial information, and the sound source spatial information.

15. The electronic device according to claim 14, wherein
the parameter for spatial audio rendering comprises a set of spatial impulse responses and/or a reverb duration.

16. The electronic device according to claim 15, wherein
the set of spatial impulse responses comprises a spatial impulse response for a direct sound path and/or a spatial impulse response for an early reflection sound path.

17. The electronic device according to claim 15, wherein the reverb duration is calculated based on the estimated scene model.

18. The electronic device according to claim 15, wherein the set of spatial impulse responses is calculated based on the estimated scene model, the listener spatial information, and the sound source spatial information.

19. The electronic device according to claim 15, wherein the encoded audio signal comprises:
a spatial audio encoding signal of a direct sound, and/or a mix signal,
wherein the mix signal comprises a spatial audio encoding signal of late reverb and/or a spatial audio encoding signal of an early reflection sound.

20. A non-transitory computer-readable storage medium having thereon stored a computer program which, when executed by a processor, implements the steps of:
determining a parameter for spatial audio rendering based on metadata, wherein the metadata comprises at least a part of acoustic environment information, listener spatial information, and sound source spatial information, and the parameter for spatial audio rendering indicates a characteristic of sound propagation in a scene in which a listener is located;
processing an audio signal of a sound source based on the parameter for spatial audio rendering, so as to obtain an encoded audio signal; and
performing spatial decoding on the encoded audio signal, so as to obtain a decoded audio signal.
